(19) United States
(12) Patent Application Publication
(10) Pub. No.: US 2009/0217236 A1
(43) Pub. Date: Aug. 27, 2009

(54) METHOD FOR RECOVERY OF TRACEABILITY LINKS

(75) Inventors: Patrick Mader, Bad Frankenhausen (DE); Tobias Kuschke, Bad Frankenhausen (DE); Ilka Phillippow, Ilmenau (DE)

Correspondence Address: MAYER & WILLIAMS PC, 251 NORTH AVENUE WEST, 2ND FLOOR, WESTFIELD, NJ, 07090, US

(73) Assignee: TECHNISCHE UNIVERSITAT IIMENAU, Ilmenau (DE)

(21) Appl. No.: 12/352,561

(22) Filed: Jan. 12, 2009

(30) Foreign Application Priority Data
Jan. 11, 2008 (DE) 10 2008 000 043

(51) Int. Cl. G06F 9/44; G06N 5/02

(52) U.S. Cl. 717/105; 706/47; 717/104

(57) ABSTRACT

The invention relates to a method for recovery of the traceability links among the model elements when there are changes in at least one of the model elements in a system model. According to the invention, first an elementary change in an observed model element having at least one traceability link is detected. Then the detected elementary change is compared with predetermined change activities that are defined by one or more elementary changes and predetermined changes in links. The detected elementary change is assigned to all predetermined change activities in which a suitable elementary change is defined. Finally, the recovery of the traceability links of the modified model element takes place according to the predetermined changes in links when all elementary changes of the predetermined change activity have been detected.

### BACKGROUND OF THE INVENTION

The present invention relates to a method for recovery of the traceability links which describe the dependencies and relationships between and among elements and/or submodels within a system model.

Technical systems today often consist of a complex arrangement of numerous components that are interlinked and can execute complex functions within this connection. The increasing complexity of systems pertains to a wide variety of application cases, e.g., in the interaction of mechanical, electric, electronic and/or technical software components. Neither the functional variety nor the construction and interaction of the individual components can be comprehended without any additional help in the case of complex systems. This often results in a high level of complexity in further development of such systems or in finding errors. For a correct understanding of such a complex system, knowledge of all the linkages among the components and the resulting variety of functions is necessary.

Integrated electronic circuits may be considered as an example of complex systems of this type in which the individual components are electronic modules or, in a more differentiated plane of abstraction. Likewise, an efficient software application constitutes a complex system comprising numerous program libraries and software routines as components. For the development of efficient software, a wide variety of program libraries or comparable modules are combined with one another today, with various programmers working on the creation of these libraries and the components subsequently being combined by other people. For example, a complex drive unit in a machine is one example of such a complex system to which the present invention can be applied.

To make the development of such systems efficient and as error-free as possible, theoretical structuring techniques are used, in particular abstraction, hierarchization and decomposition. The system to be developed is broken down within multiple abstraction steps into smaller and smaller components until they can be handled by the developer and all their functions are readily comprehensible. The same facts of the case are illustrated repeatedly over various abstraction steps with increasing precision. To be able to track the average development process, references between and among individual components are created. These references are usually known as traceability links. With the help of these traceability links, starting from a requirement that is to be met by the complex system, it is readily possible to discover the components required for implementation of this requirement in the development system. This allows a subsequent adaptation of the system and estimation of the manpower required for a change. At the same time, it is possible with the help of traceability links to provide proof that certain requirements have in fact been met by the system. Continuous documentation of the traceability links is extremely helpful when new operators are to be introduced to the functioning of such a system. Especially if a system has gone through multiple revision processes, it is possible to track on the basis of the traceability links whether certain components are still necessary at all to fulfill the new requirements. This makes it possible to slim down software applications by removing superfluous components, for example.

US 2007/0106982 A1 discloses a model-based traceability network which is supplied in an integrated development environment. This network comprises a basic model that is generated by an administrator via a tabular system. Special tools used by this network allow the development and management of the traceability links that are generated during code generation or manually via a user interface. An administrator is responsible for maintaining the model by entering the traceability links into tables, for example. However, automatic updating and/or recovery of the traceability links is impossible with this known network.

Although the positive effects of documentation of traceability links or traceability of a development process are known, these aids are rarely used in practice. One of the main reasons for this is the high manual effort required to generate and maintain the traceability links in the system models that are used for documentation of real systems. The development of complex systems usually takes place as an iterative, incremental and evolutionary process, so an enormous effort is required to maintain the traceability links among individual components. Once the traceability links have been established, they lose their validity in the further development process if the structure of the system is altered without tracking the traceability links.

### SUMMARY OF THE INVENTION

The object of the present invention thus consists of providing a method for automatic recovery of the traceability links among model elements by means of which the traceability links are updated and are recovered when there are changes in the system model without requiring any manual intervention to do so.

This object is achieved by the method characterized in claim 1.

It is essential for the inventive method that in a first step, an elementary change is detected on a model element observed in the system model. This observed model element has at least one traceability link to other model elements, which may be affected by the elementary change and may have to be recovered. In a downstream method step, the elementary change detected is compared with predetermined change activities. The change activities are defined by one or more elementary changes and predetermined changes in links. As a result of this comparison, the elementary change thus detected is assigned to all predetermined change activities in which a suitable elementary change is defined. In a concluding method step, the traceability links of the modified model element are recovered according to the predetermined changes in links when all elementary changes in the predetermined change activity have been detected.

An important advantage of the inventive method is that the traceability links can also be maintained completely and correctly within the system model even when there are structural changes without requiring a system development or administrator to make a manual adjustment. The inventive method can be used for any type of system models if the elementary changes in model elements there can be detected and if a finite number of change activities can be defined. This is true in particular of models which are used as part of a system development, e.g., CAD models, simulation models and models in the software development process.

The manual effort to maintain the traceability links can be reduced significantly by using the inventive method, so that traceability links can now also be used on a wide scale in industrial development of systems. The error susceptibility in recovery of the traceability links is reduced in comparison with manual recovery. The inventive method can also be used in combination with manual recovery if all conceivable change activities are not detected automatically by the method.

The addition, deletion or alteration of a model element is preferably defined as elementary changes to be detected. By detecting multiple elementary changes resulting from a parallel change in the system model, change activities that belong to together semantically can be detected with the help of the inventive method. For each change activity detected, it is possible to define a change in link that must be implemented to return existing traceability links to a consistent state after a change in the model. For correct recognition of the change activity, in addition to detecting the elementary changes, it is also necessary to detect the properties of the observed/changed model element which are manifested outwardly to determine from them the semantic correlations among multiple elementary changes. When a model element is added, its properties exist only after creation of the model element. When a model element is deleted, its properties exist only before the actual deletion operation. When there is a change in a model element, its properties may change because of the elementary change. To determine the suitable predetermined change activity, therefore in a preferred embodiment of the method, as part of the detection of the elementary change, the property values of the model element before the elementary change are also stored and the stored values are compared with the property values of the model element after the elementary change.

The elementary changes detected in the first method step describe the changes performed by a system developer through development of the system model. The elementary changes detected do not alone directly allow the detection of the change in the model element if the change that is performed goes beyond a change in the properties of the model element. However, precisely the structural changes in which the original model element is replaced, divided or combined from multiple subordinate elements lead to inconsistencies in the traceability links. These so-called change activities with effects on the structure of the system model thus usually consist of several detectable elementary changes. The inventive method now makes it possible to correctly detect such structural change activities which have an influence on the traceability links and track them according to the predetermined changes in links. In a comparison of the elementary changes thereby detected, according to a preferred embodiment, multiple elementary changes are thus compared with a predetermined change activity to detect a corresponding agreement which is made up of one or preferably more elementary changes, the traceability links are recovered according to the predetermined changes in links assigned to the change activity.

According to a preferred embodiment of the inventive method, detection rules which include previously defined templates of elementary changes and anticipated correlations among multiple elementary changes are used for the detection of the change activities. The elementary changes detected initially are compared with the templates and assigned to the corresponding template in the case of a match. Each detection rule is assigned one-to-one to a certain change activity, so that one detection rule allows the detection of precisely one change activity.

Multiple templates are preferably assigned to one detection rule. Within the detection rule, the sequence of individual templates which can be assigned to corresponding elementary changes does not matter. Multiple methods are usually available for performing a desired structural change in a system model. By defining the detection rule, the inventive method makes it possible to detect a defined change activity regardless of the sequence of elementary changes performed. For each alternative implementation pathway, a so-called triggering elementary change is preferably defined, such that the occurrence of said triggering elementary change establishes a semantic correlation between the multiple elementary changes and the change activity being sought.

Each detection rule consists in principle of the following components:

```
Rule n {
    Alternative implementation pathway 1 {
        Template of the triggering elementary change
        Template of the elementary change 1
        ...
        Template of the elementary change n
        Action to ensure consistency of the references
        }
    Alternative implementation pathway 2 {
        Template of the triggering elementary change
        Template of the elementary change 1
        ...
        Template of the elementary change n
        Action to ensure consistency of the references
        }
    ...
    Alternative implementation pathway n {
        ...
        }
    }
```

According to a preferred embodiment, the detection of change activities does not proceed dynamically with respect to all activities. This makes it possible to reduce the manpower required for detecting the elementary changes. Instead of this, there is a search for anticipated/predefined activities in the elementary changes performed by the developer. To be able to search for these activities, they must first be defined. This is done with the help of the above-mentioned “templates.” Templates are structured exactly like the elementary change being sought by them. However, they additionally offer the possibility of defining the anticipated properties of an element modified by the elementary changes. These properties may be defined as fixed values that are irrelevant for the comparison and are dependent on other element steps of the activity being sought.

The following example illustrates the construction and use of templates:

```
Template:
    Delete (type “resistance,” name: *, stereotype:*, ...)
Elementary step:
    Delete (type “resistance,” name: “R12”, stereotype: “metal layer
    resistance,” ...)
```

In this example, deletion of a resistance is anticipated in a detection rule. To do so, a template is defined for this. The additional properties of the resistance do not play a role for the detection of the deletion step (marking: *). The stated elementary step (performed by the developer) fulfills the circumstances defined in the template. Speaking graphically: the elementary step and the template are placed one above the other, yielding as the result: the elementary change being sought either does or does not satisfy the template.

Inasmuch as the inventive method should automatically handle the recovery of the traceability links for all conceivable change activities, it is necessary for each structural change activity that has an effect on the traceability links of the modified model element to define an independent recognition rule with all the alternative implementation pathways. The defined recognition rules may be stored in a catalog of rules.

According to a modified embodiment, however, it is also possible to have an inconsistency signal generated by the method when a detected elementary change and/or a group of elementary changes does not correspond to a predetermined change activity, so no recognition rule exists for this case. Likewise, cases are also conceivable in which recognition rules are available but the help of the developer is necessary to decide between two alternatives. Here again, an inconsistency signal may be generated to open up for the developer the possibility of intervention to manually perform the recovery of the traceability links. It is likewise conceivable in such a case to define a new rule to increase the recognition rate for future similar change activities. However, the effort for maintaining the traceability links is greatly reduced even in such cases.

Additional advantages, details and further embodiments of the inventive method are derived from the following description of preferred embodiments with reference to the drawings.

### BRIEF DESCRIPTION OF THE DRAWINGS

FIG. 1 shows a basic flow chart of the inventive method in occurrence of an elementary change.

FIG. 2 shows the process sequence in a model change in an electrotechnical system model.

FIG. 3 shows the process sequence in a model change in a software system model.

### DETAILED DESCRIPTION

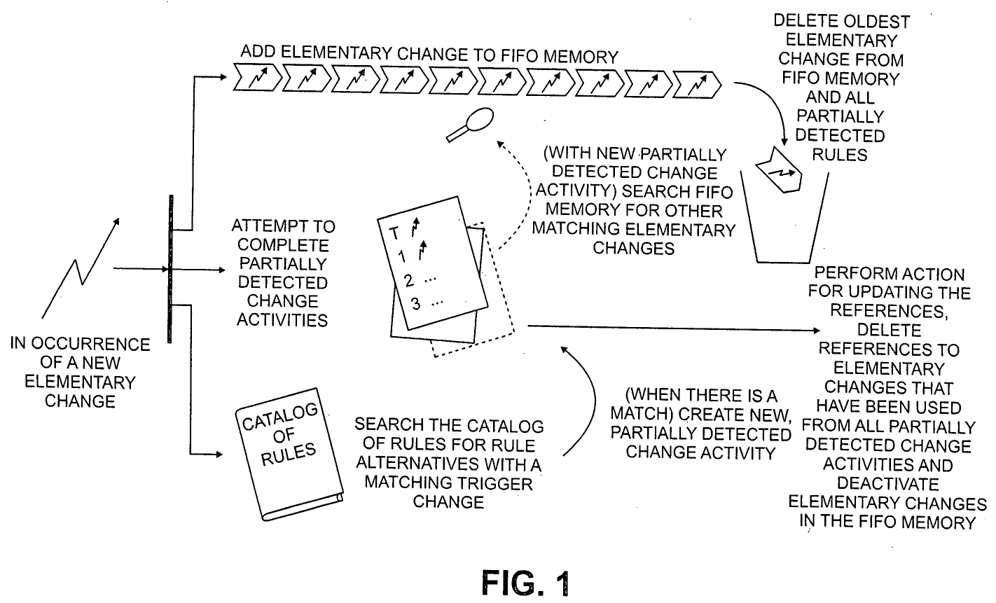

FIG. 1 shows the essential actions performed by the inventive method when an elementary change occurs within a system model. First, the elementary change detected is stored in a FIFO memory. The FIFO memory has a predetermined capacity and advances the elementary changes that are detected from an input to an output over individual memory cells, so that when the memory is completely full, the oldest stored elementary change is deleted from the memory. On the deletion of the oldest elementary change from the memory, all references generated in the meantime to this elementary change, which might result from change activities only partially detected up to that point in time, are removed at the same time.

In another step, a check is performed to ascertain whether the elementary change occurring last is part of one or more predetermined change activities and can thus be assigned to this change activity. Since the predetermined stored change activities are usually composed of multiple elementary changes, it is possible for the elementary change that has occurred last to be assigned to various ones of the predetermined change activities. If the detected elementary change can be assigned to a predetermined change activity, then in these one or more change activities, a reference to the respective elementary change and its position in the FIFO memory is set.

As soon as the predetermined change activity has been detected completely due to the correlation of the elementary change with it, the predetermined changes in links assigned to the respective change activity are performed for recovery of the traceability links. The recovery of the traceability links of all the model elements belonging to a predetermined change activity is thus triggered only when all the elementary changes assigned to a predetermined change activity have been detected.

When the recovery of the traceability links is performed according to the predetermined relation changes, so that a change activity has been recognized completely, the references to the elementary changes used are also deleted completely, i.e., the references directed from other change activities to the elementary changes detected. The elementary changes used in the completely detected change activity are deactivated or deleted in the FIFO memory so that they cannot be assigned to any other change activities.

In many cases, the detection of an elementary change will not lead immediately to a complete detection of a predetermined change activity. In the process sequence depicted in FIG. 1, the elementary change detected last is also checked for whether it corresponds to a so-called triggering elementary change which is assigned to a detection rule stored in a catalog of rules. If such a correspondence is found, it triggers the application of a new partially detected change activity to which additional elementary changes can be assigned for completion. The newly created change activity in turn contains a reference to the elementary change stored in the FIFO memory. Furthermore, a check is performed on whether there are already additional elementary changes in the FIFO memory that can be used to complete the newly created change activity. If suitable elementary changes are discovered, then corresponding references to the elementary changes are created in the manner already explained. If the new change activity can be completed in this way, it leads in turn to triggering of the step of recovery of the traceability links as already described above.

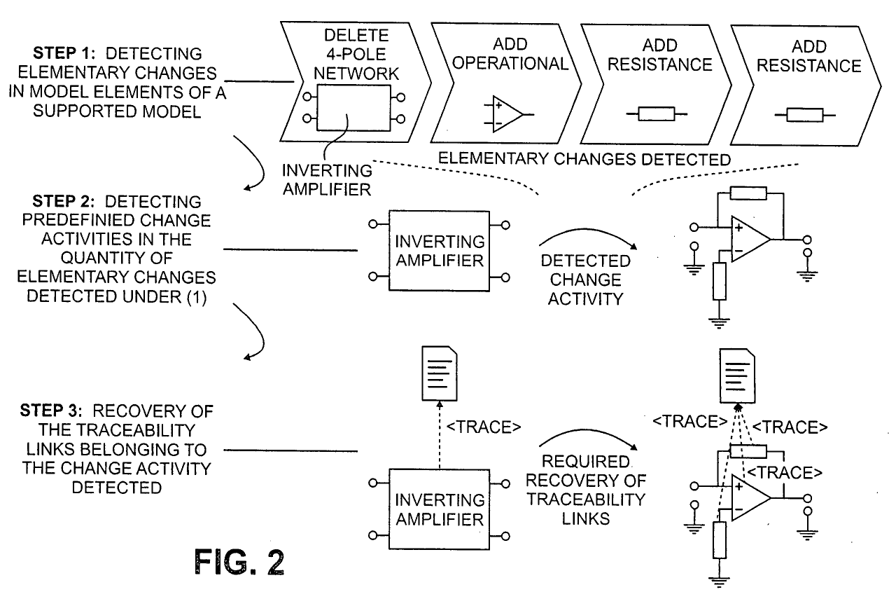

FIG. 2 illustrates the method steps that take place when a model change occurs in an electrotechnical system model. The change activity depicted here relates to the refinement of a system draft for conversion to a wiring diagram. To do so, the quadrupole of the inverting amplifier type, which is initially modeled only in abstract terms, is replaced by a specific wiring diagram. The elementary changes that have been performed and detected are depicted in the top row of FIG. 2. These are four elementary changes, namely deletion of the quadrupole, addition of an operational amplifier and the addition of two resistors. The middle row of FIG. 2 illustrates the fact that after detection of the four elementary changes, they were assigned to a predetermined change activity and thus this change activity was detected completely. All the required changes in links needed for recovery of the traceability links have been assigned to the predetermined change activity. The third row in FIG. 2 illustrates the recovery of the traceability links, which concludes the inventive method.

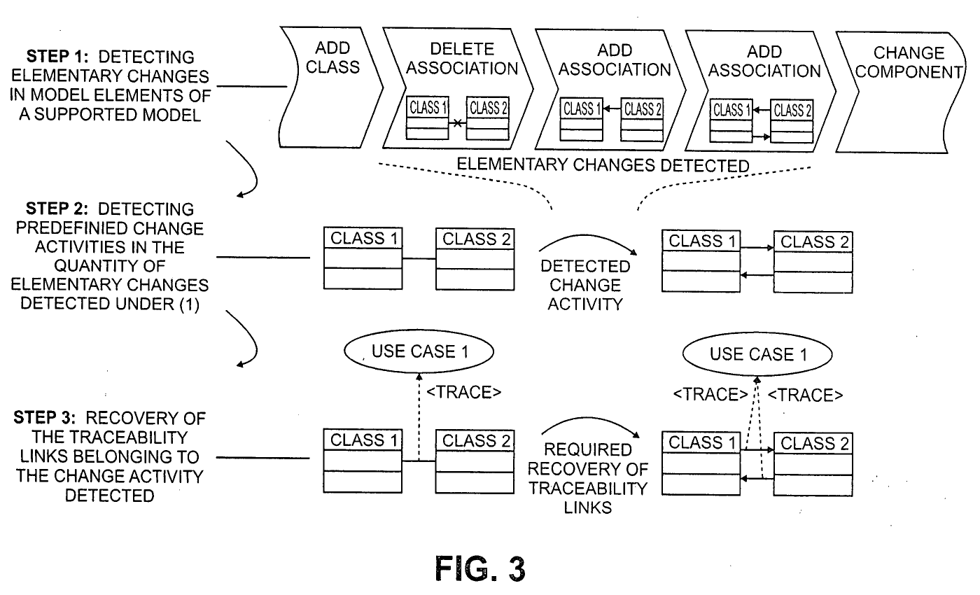

FIG. 3 illustrates the essential method steps on the example of recovery of the traceability links with a change in a system model which illustrates a typical structure in a software system. A complex software can be modeled with the help of a unified descriptive language such as the Unified Modeling Language (UML), for example. The top row of FIG. 3 shows the elementary changes which are implemented to refine the structure in the software development process. The middle row in FIG. 3 in turn illustrates the detection of a change activity comprising the multiple elementary changes. The bottom row in FIG. 3 illustrates how the modified traceability links are recovered to ensure their consistency with the modified system model.

As already explained in the introduction, the inventive method can be applied to a variety of system models for recovery of the traceability links when changes are performed in the system that can be subdivided into individual elementary changes.

1. A method for recovery of the traceability links between model elements when there are changes in at least one of the model elements in a system model, comprising the following steps:
detection of an elementary change in an observed model element, which has at least one traceability link;
comparison of the detected elementary change with predetermined change activities defined by one or more elementary changes and predetermined changes in links and assigning the detected elementary connection to all predetermined change activities in which a suitable elementary change is defined;
recovery of the traceability links of the modified model element according to the predetermined changes in links when all the elementary changes in the predetermined change activity have been detected.

2. The method according to claim 1, wherein the addition, deletion or change in the model element is detected as an elementary change.

3. The method according to claim 1, wherein the step of detection of the elementary change comprises storage of property values of the model element before the elementary change as well as a comparison of these store values with the property values of the model element after the elementary change.

4. The method according to claim 1, wherein the predetermined change activities comprise multiple elementary changes.

5. The method according to claim 1, wherein each predetermined change activity and the changes in links assigned thereto are stored as a template or a group of templates, such that the detected elementary change is compared with the stored templates in the comparison step and assigned to the corresponding template.

6. The method according to claim 5, wherein each template is assigned one-to-one to a certain elementary change.

7. The method according to claim 5, wherein multiple templates are assigned to one recognition rule, which is applied in the comparison step to define a correspondence of multiple detected elementary changes with a predetermined change activity.

8. The method according to claim 7, wherein each recognition rule is assigned one-to-one to a certain change activity.

9. The method according to claim 7, wherein the recognition rule tolerates different sequences of the templates assigned to it in order to define the correspondence with the predetermined model of the predetermined change activities.

10. The method according to claim 7, wherein the recognition rule detects a triggering elementary change and on detection of said triggering elementary change a predetermined change activity that is to be completed is activated.

11. The method according to claim 1, wherein each detected elementary change is stored in a memory; its correlation with incompletely detected change activities is stored and it is blocked for further comparisons with change activities as soon as it has been assigned to a completely detected change activity.

12. The method according to claim 11, wherein on complete detection of a change activity, the existing correlations between detected elementary changes which are assigned to the completely detected change activity and incompletely detected change activities are deleted.

13. The method according to claim 1, wherein an inconsistency signal is output when a detected elementary change does not correspond to a predetermined change activity.

14. The method according to claim 1, wherein the system model is formed by an electric wiring diagram.

15. The method according to claim 1, wherein the system model is formed by a structural diagram of a software system.
